(19) United States
(12) Patent Application Publication
(10) Pub. No.: US 2006/0277088 A1
(43) Pub. Date: Dec. 7, 2006

(54) Method of determining a target event of a re-occurring event

(76) Inventor: Vic Cinc, Baulkham Hills (AU)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/432,306

(22) Filed: May 11, 2006

(30) Foreign Application Priority Data
May 12, 2005 (AU) 2005 902411

(51) Int. Cl. G06F 9/46

(52) U.S. Cl. 705/8

(57) ABSTRACT

The present invention provides a computer implemented method of determining a target event of a re-occurring event in time. The method comprises determining at least one cycle relative to an origin. The or each cycle has a period that is associated with the re-occurrence of the re-occurring event and the period is greater than one day. The method further comprises applying at least one target event operator to the or each cycle to determine the target event of the re-occurring event.

### FIELD OF THE INVENTION

The present invention broadly relates to a method of determining a target event of a re-occurring event.

### BACKGROUND OF THE INVENTION

Many events are re-occurring in a domestic or commercial environment. For example, events that re-occur in a domestic environment include birthdays, anniversaries and public holidays. In a commercial environment such events may include schedules for transactions, deadlines, or meetings.

For example, a company may wish to schedule a staff meeting for the first Monday of every month. For planning purposes it may be required to determine a target event of this re-occurring event, such as the specific dates for every first Monday of a range of months that follow. Alternatively, a person may wish to determine the weekday of Christmas in a particular year.

Using a calendar to obtain this information is often not convenient and there is a need for an alternative method for determining a target event of a re-occurring event.

### SUMMARY OF THE INVENTION

The present invention provides in a first aspect a computer implemented method of determining a target event of a re-occurring event in time, the method comprising:

determining at least one cycle relative to an origin, the or each cycle having a period that is associated with the re-occurrence of the re-occurring event, the period being greater than one day, and

applying at least one target event operator to the or each cycle to determine the target event of the re-occurring event.

The step of determining the or each cycle typically comprises applying a first format operator to the or each cycle and which converts a format of the or each cycle into a numerical format that is related to numbers.

Throughout this specification the terms “number” is used for any number or representation of a number including binary data. For example, the first format operator may be an operator that converts a date into a number relative to the origin. The target event operator typically is a logical operator or a numerical operator which delivers a result after performing an operation according to predetermined rules. The method typically comprises the additional step of applying a second format operator that converts a numerical format of the determined target event into a day, date or period.

In a first specific embodiment the target event is a particular day, date or period. For example, the target event may be that date of the last Monday before 23 May 2003. In this example, a cycle may have a seven day period starting at a predetermined origin. The cycle typically has a predetermined off-set between 0 and 7 to account for the particular week day, in this specific example the off-set may be 1 as Monday is the first day of a week. In this example the selected cycle comprises Mondays and the target event operator, applied to the cycle, would conduct a numerical operation that selects the last Monday before 23 May 2003.

In a second specific embodiment the method comprises

determining a first cycle having a period that is associated with the re-occurrence of a first re-occurring event,

applying a first target event operator associated with a first target event to the cycle,

determining a second cycle having a period that is associated with the re-occurrence of a second re-occurring event and

applying a second target event operator to the second cycle and using the first target event as input for the second target event operator.

The following will describe a specific example of the method according to the second specific embodiment. In this example the first target event is the last Monday before 23 May 2003 and the second target event is the last Friday before that Monday. The first and second cycles have seven day periods which start at predetermined dates and have predetermined off-sets to account for the particular week days. The first cycle comprises Mondays and the first target event operator identifies the date of the last Monday before 23 May 2003. The second cycle comprises Fridays and the second target event operator identifies the date of the last Friday before the first target event.

For example, the re-occurring event may be a public holiday such as Easter or Christmas or any other public holiday, a particular date such as a birthday date, a date for a meeting, a maintenance date, a computer back-up date, a date in banking of financing industry such as the date for a financial transaction or any other event that re-occurs.

The or each target event may be a series of target events.

The or each target event may be a feature of the event at the re-occurrence of the event in the future. Alternatively, the or each target event of the re-occurring event may be a feature of the event in the past. The or each target event may be a particular year, month, week, day week in a month or year, or a date or a particular series thereof.

The or each cycle may have a period of a day, a week, a month, or the period may be a lunar period. For example, the re-occurring event may be a birthday, the or each cycle may have a period of one year and the target event of the re-occurring event may be the weekday of the birthday in a particular year.

It is to be appreciated that the invention is not limited to the above examples of events, target events, cycles and offsets and that there are a large number of additional examples that are within the scope of this aspect of the invention.

The step of applying the format operator may comprise converting a feature of a Julian, Gregorian or lunar calendar into a number. In this case the method may also comprise converting the or each selected number that is associated with the target event of the re-occurring event into a feature of a Julian, Gregorian or lunar calendar.

The method may use a software schema. The computer software may use a mark-up language such as extensible mark-up language (XML).

The method may also comprise the additional step of disregarding particular numbers that are associated with a predetermined target event of the re-occurring event and the computer software may have a rule to this effect. For example the method may be used to determine the dates of the first Monday of every months and the rule may exclude public holidays.

In one embodiment, the method comprises the step of displaying the determined target event of the re-occurring event for example on a monitor of a computer, mobile phone or on another display. For example, the target event may be displayed together with information about the re-occurring event. The step of displaying may conducted so that the target event and the information about the re-occurring event is displayed in text and/or graphical from.

The method may further comprise the step of transmitting information about the determined target event of the re-occurring event. This may involve use of a mark-up language such as XML. For example, the information, such as string of selected numbers that are associated with each cycle or the target events of the re-occurring event, may be transmitted within a computer network, such as in an office, and the information may be displayed on respective computer screens. Each computer in the network may have software to process and/or to display the information.

The present invention provides in a second aspect a computer system in which the above-defined method is implemented.

The computer system may comprise a network of computers and typically also comprises a means for transmitting data within the network. Further, the computer system typically comprises at least one display for displaying information related to the target event of the re-occurring event.

The present invention provides in a third aspect a computer program for determining a target event of a re-occurring event according to the above-defined method.

The invention will be more fully understood from the following description of specific embodiments of the invention. The description is provided with reference to an accompanying drawing.

### BRIEF DESCRIPTION OF THE DRAWINGS

FIG. 1 shows a schematic representation of a system for determining a target event of a re-occurring event according to a specific embodiment of the invention.

### DETAILED DESCRIPTION OF SPECIFIC EMBODIMENTS

A method and a system for determining a target event of a re-occurring event according to a specific embodiment of the present invention is now described.

In general the method comprises the step of determining a period of at least one cycle, such as a cycle of numbers, which characterise the re-occurrence of the event and applying at least one operator to the or each cycle. The or each operator is associated with the target event. The method will now be illustrated with reference to a specific example. In this example the method is used to determine the date of the second Friday on or after the Wednesday just before 30th Jun. 2003. In this example two cycles are used to calculate the above relation. The first is a seven-day cycle with offset 3 representing Wednesday, the second cycle is a seven-day cycle with offset 5 and recurrence 2 representing the 2^{nd} Friday. The date “30^{th} of June 2003” is already fully specified and needs no cycles. This date would in this embodiment be represented as a Julian date or related string of numbers.

The first operation is to apply a “before” operator with the “Wednesday” cycle as defined above and the date “30^{th} Jun. 2003”. This operation returns a date “25^{th} Jun. 2003”. The next step comprises applying the “on or after” operator to the “Friday” cycle as defined above to the result produced above from the first step ie “25^{th} Jun. 2003” (as a Friday or a Wednesday are different days, the “on or after” operator has in this example the same function as an “after” operator). The answer for that operation is “4^{th} Jul. 2003”.

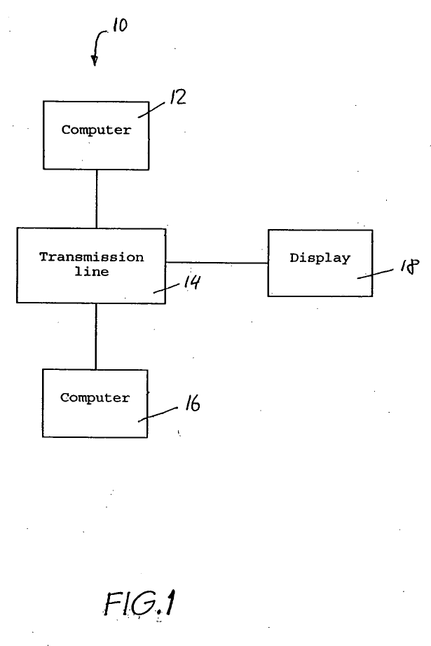

Te method is computer implemented and software is used which utilises a number of operators that are defined below. FIGS. 1 shows the system 10 which comprises in this embodiment a computer 12 that is equipped with computer software for the operation of the above-described method. The system further comprises a transmission line 14 for transmission of data from the computer 12 to another computer 16 or to a display 18.

Information about the target event of the re-occurring event and information about the event itself is in this embodiment transmitted in a network. Transmission is conducted by sending a string of data that can be decoded using the operators defined below. For example, the operators may be represented using words such as English language words and formation of the data string may comprise a mark-up language such as XML. In this embodiment, each computer of the network is equipped with software that is arranged to process the string of data so that the information can be displayed on a display. This involves usage of a graphic user interface.

The following will introduce a number of operators for implementation by suitable software. Each operator is associated with a cycle and has an input date. For example, the operator “>” may calculate a date for a re-occurring event after an input date or the operator “<” may calculate the date of the re-occurring event before the input date. In this embodiment it is assumed that a Julian representation system is used. The operators are expressed in a program language similar to Java.

Class “DayCycle”

This class is used to apply cycles to days (such as weeks or fortnights). The class has the following instance variables:
integer period (this instance variable specifies a length of a cycle),
integer offset (this instance variable specifies an offset in days relative to the start of a cycle),

integer multiple (this instance variable specifies a number of periods in a cycle).

1. Date operator “>” (Date d)
{
return (Date )(period*((int)(d − offset) /period + multiple
+1) + offset);
}
2. Date operator “<” (Date d)
{
return (Date)(period*((int)(d − offset) /period + multiple −1)
+ offset);
}
3. Date operator “>=”(Date d)
{
return (Date )(period*((int)(d − offset) /period + multiple) +
offset);
}
4.Date operator “<=” (Date d)
{
return (Date )(period*((int)(d − offset)/period + multiple) +
offset);
}

The above operator accept a date upon which the desired operation is effected and return a date as an answer. The mechanics
Class “MonthCycle”

The Monthcycle operator is slightly more complicated then the preceding class operators as it includes a function which converts the number of a date into month and years and then into a month number relative to a predetermined origin. For example, if the date is 15 Jun. 2004 and the predetermined origin is 1 Jan. 2000, the calculated number would be 42 as 42 month passed since 1 Jan. 2000. In a Julian date embodiment then that month number would be different.

These operators have the following input variables:
integer period (this instance variable specifies a length of a period in months),
integer offset (this instance variable specifies an offset in months relative to the start of a cycle),
integer multiple (this instance variable specifies a number of periods in a cycle).

A function j2dmyj(dd, mm, yy) is assumed to exist which transforms a date given by (dd. mm. yy) into a number relative to a predetermined origin and the function dmy2j(dd, mm, yy) transforms a number into a corresponding date.

1. Date Operator “>” (Date d)
{
Date operator > (Date d)
Int dd,mm;yy;
j2dmy(d, &dd, &mm, &yy);
mm += yy* 12 − 1;
// we have now converted a date into an contiguous month
//number
mm = period*((mm − offset)/period + multiple) + offset;
// we perform the same relative operation as DayCycle and
//convert the resulting month number back into a date //making
sure that the day in the month doesn't overlow //into the
following month
yy = mm/12;
mm = (mm%12) + 1;
if(dd>days-in-month(mm, yy))
dd = days-in-month(mm, yy);
return dmy2j(dd, mm, yy)+1;
}
2. Date operator “<” (Date d)
{
int dd,mm,yy;
int tmp;
j2dmy(d, &dd, &mm, &yy);
mm += yy*12 −1; /* mm needs to be O. .x−1 not 1. .x */
tmp = (mm − offset);
mm = period *(tmp/period − multiple + 1) + offset;
yy = mm/12;
mm=(mm%12) +1;
return dmy2j(1, mm, yy);
}
3.Date operator “>=” (Date d)
{
int dd,mm,yy;
int tmp;
j2dmy(d, &dd, &mm, &yy);
mm+=yy*12−1;
tmp = (mm − offset);
mm = period *(tmp/period + multiple) + offset;
yy = mm/12;
mm = (mm%12) + 1;
return dmy2j(1, mm, yy);
}
4.Date operator “<=” (Date d)
{
int dd,mm,yy;
int tmp;
j2dmy(d, &dd, &mm, &yy);
mm += yy* 12 − 1;
tmp = (mm − offset);
mm = period *(tmp/period − multiple + 1) + offset;
yy = mm/12;
mm=(mm%12)+1;
return dmy2j(1, mm, yy);
}

Using the above-described day and month classes it is possible to determine re-occurring dates by use of day and month cycles. It is to be appreciated that in this embodiment the day and month instances of the above may also be combined recursively and iteratively as each operator accepts a date and returns a date.

The system can be easily expanded to accept any type of class that follows the above schema. If for example a lunar cycle class was defined we could arbitrarily combine it with day and month instances to perform recurring calculations, which included lunations. From this for example we could create an Easter class that incorporated the above classes such that further calculations could be performed that included Easter as a native term. A lunar class cycle would need a function that converted a specifically numbered lunation to a date and vice versa.

Arbitrary types of cycles can be created if they satisfy the following basic requirements. The underlying representation of the cycle should be enumerable, continuous and monotonically increasing and any gaps in the underlying representation must be accounted for without disrupting the result continuity. A set of operators to define the above relationships can then be defined using modulo and standard arithmetic. A lunar cycle type can thus be created because each lunation can be numbered, this forms a continuous monotonically increases series upon which modulo and standard arithmetic can be used to locate desired recurring events.

SET operators can be used to enable further processing options of both the computer representation and a text or string of data representation. For example, the SET operator may be arranged to define limitations, ranges, exceptions, intersections, unions, not, xor aggregations, enumerations (such as every n^{th}, n: integer), repetitions, alternations or negations of any one of these operations. For example, the SET operator may be used to exclude particular dates if they fall on a weekend and instead use the next weekday. The SET operators can be combined or recursively applied with the previous basic operators to calculate arbitrarily complex sets of recurring dates.

Examples of SET calculations include the calculation of all Friday the 13^{th} in a particular decade a more complex example which the following grammar could be extended to provide is for example “which years in this decade have more then 1 Friday the 13^{th}”.

Macros are used to simplify transmission of the information. For example, “Monday” may be associated with a macro “Daycycle (period 7, offset 0, multiple 1)”.

Using a grammar that encapsulates the operators and seeding values embodiments of the invention incorporate the ability for storage to a storage device or transmission between computers and/or networks.

The following is an illustration of a grammar that embodies some of the above-described examples. Arbitrary grammars for the above-described system can be created and a grammar that parses a large subset of the English language descriptions of recurring dates can also be defined.

| macro: name = expr | |
|---|---|
| expr: aexpr | |
| aexpr: bexpr , bexpr | |
| bexpr: [flags] eexpr | |
| eexpr: fexpr except [if\|when] aexpr then aexpr else aexpr | |
| fexpr: every [nth\|odd\|even] aexpr in\|of bexpr | |
| fexpr: [nth last] aexpr in\|of aexpr | |
| fexpr: [this\|last\|next\|prev\|end of] zexpr | |
| fexpr: nth\|end of bexpr | |
| fexpr: [[from] bexpr] [till\|until\|for] bexpr | |
| fexpr: between bexpr [and] bexpr | |
| fexpr: zexpr | |
| zexpr: iexpr [ flags ] | |
| iexpr: rexpr [ & rexpr ] // intersection | |
| rexpr: texpr..texpr | // range flatener |
| texpr: sexpr to sexpr | // iteration expression |
| sexpr: @ xexpr | // compress overlaps |

| xexpr: cexpr [ ‘repeat’ \| ‘%’ cnt ] // repetition | |
|---|---|
| cexpr: cycle | // cycle >= d |
| cexpr: rangexpr | |
| cexpr: cycle | // missing op and date |
| cexpr: cycle oper | // missing date |
| cexpr: cycle oper bexpr | // complete expression |

| cexpr: constant [+\|−] expr | |
|---|---|
| cexpr: cycle + constant // increment cycle ie (week+1) | |
| cycle: cycle cycle | |
| cycle: [cnt \| [cnt] cnt ‘/’ \| “end”] period | |
| rangexpr: ( aexpr ) oper bexpr | |
| rangexpr: ( aexpr ) | |
| rangexpr: date | |
| repeat: cnt | |
| constant: ( constant ) | |
| constant: rangexpr − datexpr | |
| constant: mull [ ‘+’ \| ‘−’] constant | |
| period: date..date | // period covering duration |

mull: int
mull: int */ mull
mull: int */ ( constant )
rangexpr: ‘(‘ aexpr ’)’
period: d[] mon..fri m[] jan..dec week fortnight month annual
year
cnt: 0..9+

The ability to generate dates from string based definitions defined by grammars allows a re-occurring date definition to be stored in a text file or in a database or other computer storage system, for example as a list of holidays or other events. The secondary benefit is that the string based recurring date definition could be converted to ascii or XML or binary or other representation and transmitted between for example computers on a network or a server and a mobile phone etc.

Examples of Stored Definition:
Arbor Day: last Friday in April
Mothers Day: 2nd Sunday>=May
Fathers Day: 3rd Sunday>=June

The target event of the re-occurring event and the re-occurring event itself is displayed using a graphical user interface.

Although the invention has been described with reference to particular examples, it is to be appreciated by those skilled in the art that the invention may be embodied in many other forms. For example, the step of determining periods of at least two cycles of numbers, may comprise determining the periods of three or more cycles. In this case the step of calculating numbers that are associated with the period of respective cycles may comprise calculating numbers that are associated with the three or more cycles.

It is to be appreciated that the above-described method and system may alternatively be used to determine re-occurring events on any time-line. A function may be is provided that accounts for any discontinuities that a time recording system may have. This ability can be combined with the above-described date-based system for example for calculating times for meetings and other time based events in relation to recurring dates as defined above. In this case at least one cycle has a period that is shorter than one day, such as a few hours, one hour, minutes, seconds or any other period that is shorter than one day.

1. A computer implemented method of determining a target event of a re-occurring event in time, the method comprising:
determining at least one cycle relative to an origin, the or each cycle having a period that is associated with the re-occurrence of the re-occurring event, the period being greater than one day, and
applying at least one target event operator to the or each cycle to determine the target event of the re-occurring event.

2. The method of claim 1 comprising applying a first format operator to the or each cycle and which converts a format of the or each cycle into a numerical format that is related to numbers.

3. The method of claim 1 wherein the target event operator is a logical operator that delivers a result after performing an operation according to predetermined rules.

4. The method of claim 2 wherein the or each target event operator is a numerical operator which delivers a result after performing an operation according to predetermined rules.

5. The method of claim 2 comprising the additional step of applying a second format operator that converts a numerical format of the determined target event into a day, date or period.

6. The method of claim 1 comprising:
determining a first cycle having a period that is associated with the re-occurrence of a first re-occurring event,
applying a first target event operator associated with a first target event to the cycle,
determining a second cycle having a period that is associated with the re-occurrence of a second re-occurring event and
applying a second target event operator to the second cycle and using the first target event as input for the second target event operator.

7. The method of claim 1 wherein the or each target event of the re-occurring event is a feature of the event in the future.

8. The method of claim 1 wherein the or each target event of the re-occurring event is a feature of the event in the past.

9. The method of claim 1 wherein the step of applying a first format operator comprises applying a format operator that converts a feature of a Julian, Gregorian or lunar calendar into a number.

11. The method of claim 2 comprising the step of disregarding particular numbers that are associated with a predetermined target event of the re-occurring event.

12. The method of claim 1 comprising the step of displaying a determined target event of the re-occurring event.

13. The method of claim 1 comprising the step of transmitting information about a determined target event of the re-occurring event.

14. A computer system in which the method according to claim 1 is implemented.

15. A computer program for determining a target event of a re-occurring event according to the method of claim 1.

16. The method of claim 4 comprising:
determining a first cycle having a period that is associated with the re-occurrence of a first re-occurring event,
applying a first target event operator associated with a first target event to the cycle,
determining a second cycle having a period that is associated with the re-occurrence of a second re-occurring event and
applying a second target event operator to the second cycle and using the first target event as input for the second target event operator.
